(19) United States
(12) Patent Application Publication
(10) Pub. No.: US 2007/0174739 A1
(43) Pub. Date: Jul. 26, 2007

(54) Disk device, method of writing data in disk device, and computer product

(75) Inventor: Osamu Yoshida, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/377,691

(22) Filed: Mar. 16, 2006

(30) Foreign Application Priority Data
Dec. 26, 2005 (JP) 2005-373329

(51) Int. Cl. G06F 11/00

(52) U.S. Cl. 714/54

(57) ABSTRACT

In a disk device, data received from a higher-level device is written in an unused area in the buffer memory. It is checked whether the received data includes a error data. If there is error data, effective data among the received data is specified. It is then checked whether there is common data in the effective data and data already present in the buffer memory before writing the received data in the buffer memory to be written at same address in the disk medium. If there is common data, the data corresponding to the common data among the data already present in the buffer memory is deleted from the buffer memory.

### BACKGROUND OF THE INVENTION

1. Field of the Invention

The present invention relates to a technology for preventing data loss in a buffer memory of a disk device.

2. Description of the Related Art

Disk devices including a serial interface such as a serial AT attachment (ATA) are typically provided with a write cache function to enhance access performance. Specifically, write data received from a higher-level device is temporarily input to a buffer memory in the disk device, and a write completion notification is issued to the higher-level device at this stage. Subsequently, at a predetermined timing, the data accumulated in the buffer memory is written into a disk medium.

In such disk devices, when a write error occurs while writing the data accumulated in the buffer memory into the disk medium, data remaining in the buffer memory, which is not yet written into the disk medium, needs to be relieved.

In a disk device disclosed in Japanese Patent Application Laid Open No. H2-64815, when a write error occurs, subsequent writing processing is suspended. Subsequently, when another instruction to write data into the disk medium is received from the higher-level device, error information is notified to the higher-level device. Upon receiving a restart command notified by the higher-level device according to the error information, the disk device resumes the suspended write processing.

In the conventional disk device including the write cache function, when the data received from the higher-level device to be written into the buffer memory has a common write address with data that is already accumulated in the buffer memory, the data already accumulated in the buffer memory at the common write address is overwritten by the data received from the higher-level device.

Accordingly, the data to be written over the data in the common write address, and data in front of and after the data of the common write address can be allocated continuously in the order of the write address. Thus, the disk device can efficiently write data accumulated in the buffer memory into the disk medium.

However, errors in the disk device including write cache function are mainly write errors that occur when data accumulated in the buffer memory is written into the disk medium, and communication errors that occur at the interface when data is input from the higher-level device.

In the disk device including the serial interface, data received from the higher-level device is sent in units of packet data including data in a plurality of sector units. The packet data includes cyclic redundancy check (CRC) data generated based on contents of the packet data before being transferred to the disk device. The disk device can check whether a communication error has occurred at the interface by comparing the CRC data before being transferred and CRC data generated based on contents of the packet data after being transferred.

When a communication error is detected in the data, the disk device requests the higher-level device to the data once again. However, sometimes the correct data sent again cannot be received properly because of a communication error at the interface.

Under such circumstance, when the data already stored in the buffer memory is overwritten by new data with the common address, the correct data already stored is overwritten and erased by the error data.

### SUMMARY OF THE INVENTION

It is an object of the present invention to at least solve the problems in the conventional technology.

According to an aspect of the present invention, a disk device connected to a higher-level device via a serial interface and that writes data received from the higher-level device on a disk medium, includes a buffer memory configured to store therein data; a buffer writing unit that writes data received from the higher-level device in an unused area in the buffer memory; a effective data deciding unit that checks whether received data includes an error, and decides effective data among the received data when the received data includes error, the effective data being data other than data corresponding to the error among the received data; a common data checking unit that checks whether there is common data in the effective data and data already present in the buffer memory before writing the received data in the buffer memory to be written at same address in the disk medium; and a deleting unit that deletes, when the common data checking unit decides that there is common data, data corresponding to the common data among the data already present in the buffer memory.

According to another aspect of the present invention, a method of writing data received from the higher-level device on a disk medium with a disk device, the disk device including a buffer memory configured to store therein data the disk device, includes writing data received from the higher-level device in an unused area in the buffer memory; first checking including checking whether received data includes an error; deciding effective data among the received data when it is decided at the first checking that the received data includes error, the effective data being data other than data corresponding to the error among the received data; second checking including checking whether there is common data in the effective data and data already present in the buffer memory before writing the received data in the buffer memory to be written at same address in the disk medium; and deleting, when it is decided at the second checking that the buffer memory contains common data, data corresponding to the common data among the data already present in the buffer memory.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a disk device according to an embodiment of the present invention;

FIG. 2 is a schematic for explaining an operation of specifying effective data;

FIG. 3 is a flowchart of a write data selecting processing performed by a disk write-data selecting unit shown in FIG. 1;

FIG. 4 is a flowchart of an error-data specifying processing mentioned in FIG. 3;

FIG. 5 is a flowchart of an effective-data specifying processing mentioned in FIG. 3; and

FIG. 6 is a flowchart of a write-data merging processing mentioned in FIG. 3.

### DETAILED DESCRIPTION OF THE PREFERRED EMBODIMENTS

Exemplary embodiments of the present invention will be described below with reference to accompanying drawings. The present invention is not limited to these embodiments.

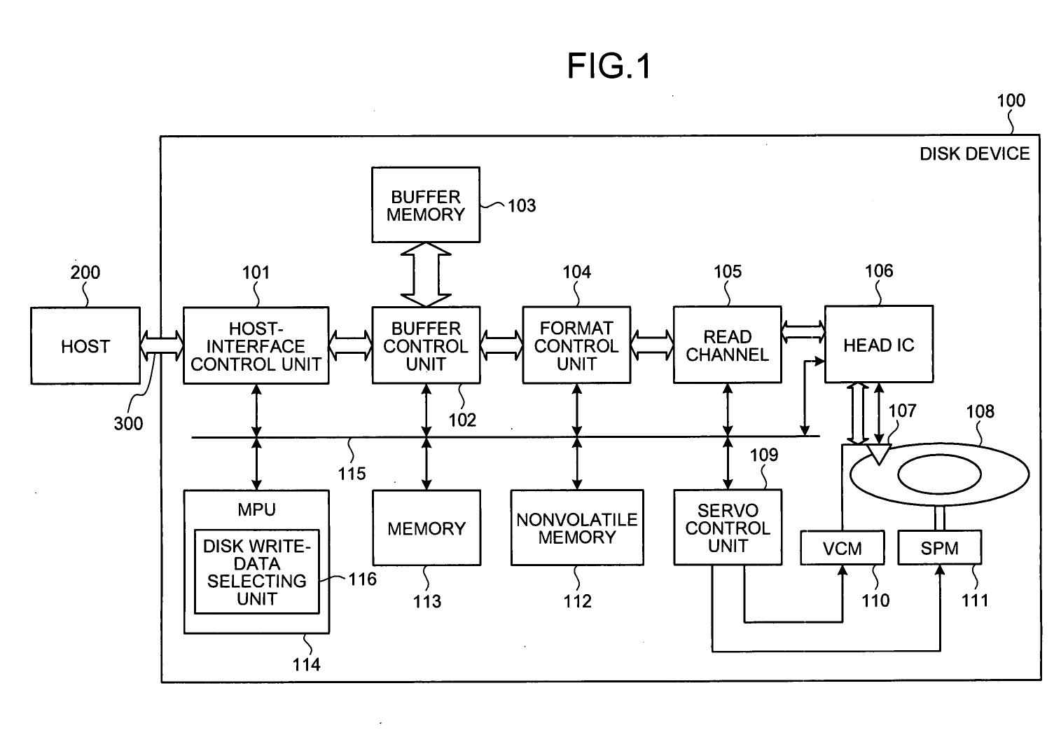

FIG. 1 is a block diagram of a disk device 100 according to an embodiment of the present invention. The disk device 100 is a magnetic disk device. The disk device 100 is connected to a host 200 (higher-level device) through a host interface 300. The host 200 is, for example, a personal computer. The host interface 300 is, for example, a serial ATA interface.

The disk device 100 includes a host-interface control unit 101, a buffer control unit 102, a buffer memory 103, a format control unit 104, a read channel 105, a head integrated circuit (IC) 106, a head 107, a disk medium 108, a servo control unit 109, a voice coil motor (VCM) 110, a spindle motor (SPM) 111, a nonvolatile memory 112, a memory 113, and a microprocessor (MPU) 114.

The host-interface control unit 101, the buffer control unit 102, the format control unit 104, the read channel 105 the head IC 106, the servo control unit 109, the nonvolatile memory 112, the memory 113, and the MPU 114 are connected through a common bus 115.

The host-interface control unit 101 controls input and output of data between the disk device 100 and the host 200 through the host interface 300. Specifically, in a write operation, the host-interface control unit 101 transfers packet data received from the host 200 to the buffer control unit 102, and determines whether an error has occurred in the packet data.

The data transferred from the host 200 through the host interface 300 is transferred in units of packet data including a plurality of sector units. Each packet data includes CRC data used for detecting an error in the data. The CRC data is generated by a calculation according to a CRC method based on contents of the packet data to be transferred.

The host-interface control unit 101 generates new CRC data based on the packet data received from the host 200, and compares the new CRC data with the CRC data already included in the received packet data, and checks whether they match. When they match, the host-interface control unit 101 determines that an error has not occurred in the received packet data.

When they do not match, the host-interface control unit 101 determines that an error has occurred in the received packet data, and notifies the fact that an error has occurred to the host 200 through the host interface 300, and requests the host 200 to resend the corresponding data and following data.

In a reading operation, the host-interface control unit 101 transfers read data transferred from the buffer control unit 102 to the host 200.

The host-interface control unit 101 checks an error based on CRC data included in packet data received from the host 200, and therefore, an error can be detected at a higher precision compared to the method of performing a parity check or a check sum.

The buffer control unit 102 controls input and output of data to and from the buffer memory 103. Specifically, in a write operation, the buffer control unit 102 stores write data transferred from the host-interface control unit 101 in the buffer memory 103, and issues a write completion notification. The write completion notification issued is sent to the host 200 through the host-interface control unit 101 and the host interface 300.

The buffer control unit 102 reads the data accumulated in the buffer memory 103 at a predetermined timing (for example, when the buffer memory 103 is full), and transfers the data to the format control unit 104. The data transferred to the format control unit 104 is then sent to the head 107 through the read channel 105 and the head IC 106, and written in a specified write address in the disk medium 108.

In a read operation, the buffer control unit 102 reads data corresponding to a read address specified by the host 200 from the buffer memory 103, and transfers the data to the host 200 through the host-interface control unit 101. When the data corresponding to the specified read address does not exist in the buffer memory 103, the buffer control unit 102 instructs the format control unit 104 to read the corresponding data from the disk medium, temporarily stores the data in the buffer memory 103, and then transfers the data to the host 200.

The buffer memory 103 temporarily stores write data received from the host 200 or read data read from the disk medium, and is used for buffering a difference in a communication speed between the host 200 and the disk device 100, which is fast, and a speed of reading from/writing in the disk medium 108, which is slow.

The format control unit 104 controls writing and reading data to and from the disk medium 108. Specifically, the format control unit 104 stores correspondences between data stored in the buffer memory 103 and data stored in the disk medium 108, and controls a write operation so that data is efficiently allocated in the disk medium 108. In a read operation, the format control unit 104 transfers data read from the disk medium 108 to the buffer control unit 102.

In a write operation, the read channel 105 encodes data to be written in the disk medium 108, and transfers the data from the format control unit 104 to the head IC 106. In a read operation, the read channel 105 decodes the data read from the disk medium 108, and transfers the data from the head IC 106 to the format control unit 104.

In a write operation, the head IC 106 modulates data that the head 107 is to write in the disk medium 108, and in a read operation, the head IC 106 demodulates data that the head 107 read from the disk medium 108.

The disk medium 108 is a magnetic disk that stores data input and output between the host 200 and the disk device 100. The head 107 writes data in the disk medium 108 and reads data from the disk medium 108.

The servo control unit 109 controls operations of the VCM 110 and the SPM 111. The VCM 110 is a motor that moves the head 107 to a target position on the disk medium 108, and the SPM 111 is a motor that rotates the disk medium 108.

The nonvolatile memory 112 is a read-only memory (ROM) that stores control programs for controlling the disk device 100, and the memory 113 is a random access memory (RAM) that stores intermediate execution results of the control programs and data used for the control.

The MPU 114 controls all the units in the disk device 100 by reading the control programs from the nonvolatile memory 112 and executing the control programs. Various processings are performed in the MPU 114. The MPU 114 includes a disk write-data selecting unit 116, in which processings are performed in a write operation.

The disk write-data selecting unit 116 reconstructs data to be written in the disk medium 108. Specifically, the disk write-data selecting unit 116 deletes error data included in write data received from the host 200, specifies effective data in the write data, and checks whether data of a common write address with the effective data exists in the buffer memory 103. If the data exists, the data already stored in the buffer memory 103 at the common write address is deleted. The disk write-data selecting unit 116 operates in the MPU 114 during the write operation.

More specifically, the disk write-data selecting unit 116 searches an unused area in the buffer memory 103, and controls the buffer control unit 102 to store write data in the searched unused area.

When the host-interface control unit 101 detects an error in the data stored in the unused area in the buffer memory 103, the disk write-data selecting unit 116 removes the error data from the data to specify (or generate) effective data.

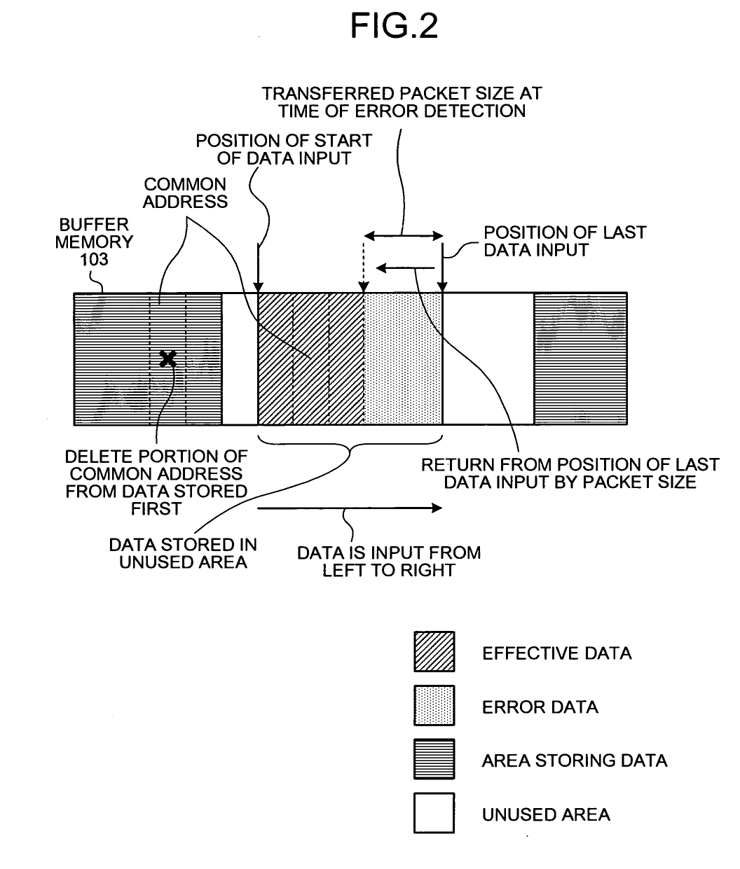

FIG. 2 depicts an operation of specifying effective data. When an error is detected in data stored in an unused area in the buffer memory 103, the disk write-data selecting unit 116 calculates a position returning from an address of an end position of last data input in the buffer memory 103 at the time of error detection, by a size of a packet data from which the error was detected. Accordingly, an end position of effective data is specified. When an error is not detected in the data received, all data stored in an unused area in the buffer memory 103 becomes effective data.

FIG. 2 depicts a case of returning the address by the size of the packet data from which the error was detected. However, when an error data is specified by a sector unit included in packet data, the disk write-data selecting unit 116 specifies an end position of effective data by calculating a position returning to a start position of the sector from which the error was detected, from an address of an end position of last data input in the buffer memory 103 at the time of error detection.

When an error data is specified by a sector unit in data received from the host 200, the error is deleted by a sector unit. When an error data is specified only by a packet unit, the error is deleted by a packet unit. Thus, the error can be deleted by finer units, so that much of the data received from the host 200 as possible can be written in the disk medium 108 as effective data.

The disk write-data selecting unit 116 compares the specified effective data and other data existing in the buffer memory 103, and if there is data in the effective area and the buffer memory 103 with a common write address, the data at the common write address already stored in the buffer memory 103 is deleted.

The disk write-data selecting unit 116 specifies error data included in write data received from the host 200, specifies effective data by removing the error data, and deletes data already stored in the buffer memory 103 that has a common write address with data in the specified effective data. Accordingly, write data accumulated in the buffer memory 103 to be, written in the disk medium 108 can be reconstructed with data from which error data is removed. Thus, data loss in the buffer memory 103, which is caused by overwriting correct data with error data, is prevented.

When the disk write-data selecting unit 116 searches an unused area in the buffer memory 103, the unused area might not be sufficient to store write data received from the host 200. In this case, the disk write-data selecting unit 116 controls the buffer control unit 102 to transfer data stored in the buffer memory 103 to the format control unit 104, to reserve a sufficient unused area. The disk write-data selecting unit 116 then stores the write data in the reserve unused area.

Accordingly, when write data received from the host 200 is to be stored in an unused area in the buffer memory 103, and the buffer memory 103 does not include a sufficient unused area for storing the write data, the disk write-data selecting unit 116 writes the data stored in the buffer memory 103 into the disk medium 108 to reserve a sufficient unused area, and stores the write data in the buffer memory 103. Therefore, even when data is frequently transferred from the host 200, the disk device 100 is able to automatically reserve an unused area and store the received data in the buffer memory 103. Thus, data loss in the buffer memory 103, which is caused by overwriting correct data with error data, is prevented.

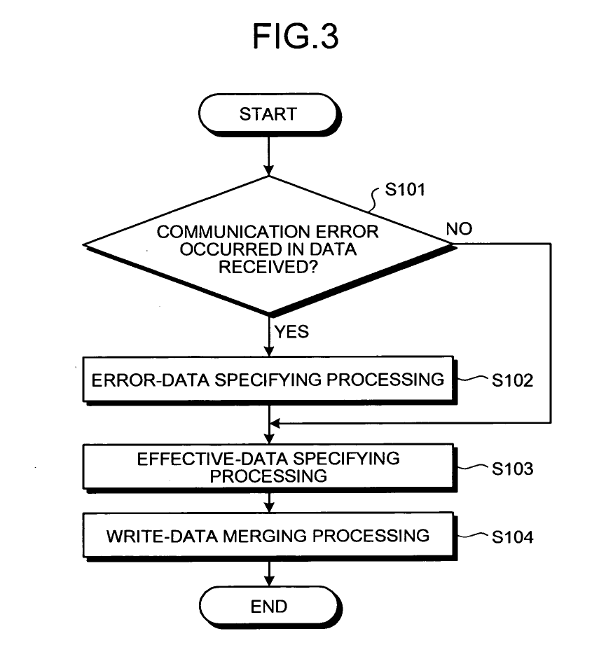

FIG. 3 is a flowchart of a write data selecting processing performed by the disk write-data selecting unit 116. When an error occurs in data received from the host 200 (Yes at step S101), the disk write-data selecting unit 116 performs an error-data specifying processing for specifying a range of error data in the data received (step S102). When an error did not occur in the received data (No at step S101), the disk write-data selecting unit 116 determines that there is no error data, and skips the error-data specifying processing.

When the range of the error data is specified by the error-data specifying processing, the disk write-data selecting unit 116 performs an effective-data specifying processing for specifying a range of effective data in the data received (step S103).

When the range of the effective data is specified by the effective-data specifying processing, the disk write-data selecting unit 116 performs a write-data merging processing for deleting data in the buffer memory 103 that has a common write address with data in the specified effective data (step S104).

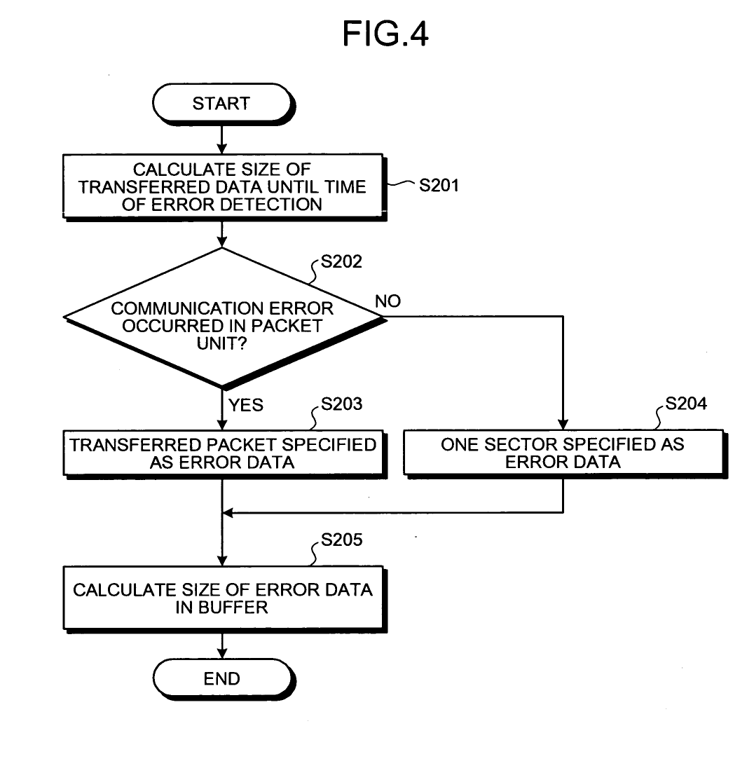

FIG. 4 is a flowchart of the error-data specifying processing mentioned in FIG. 3. The disk write-data selecting unit 116 calculates a size of the data received until the time of error detection (step S201).

The disk write-data selecting unit 116 checks whether the detected error can be confined to a sector unit in packet data. When the error can be confined to a sector unit (No at step S202), the corresponding sector is specified as error data (step S204). When the error cannot be confined to a sector unit (Yes at step S202), the whole packet data in which the error is detected is specified as error data (step S203). The disk write-data selecting unit 116 calculates a size of the specified error data (step S205).

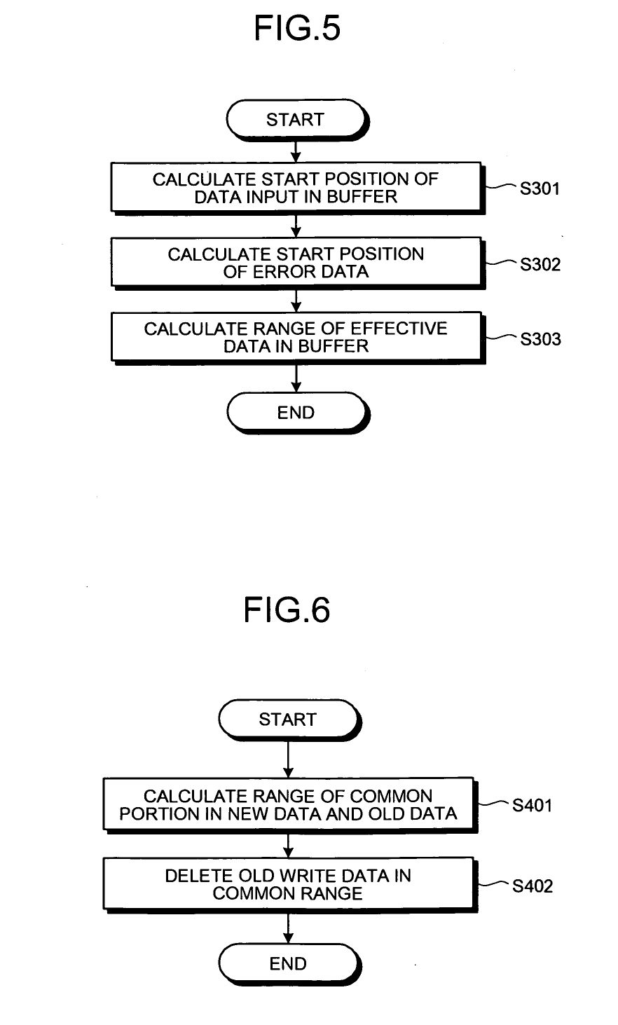

FIG. 5 is a flowchart of the effective-data specifying processing mentioned in FIG. 3. In the effective-data specifying processing, the disk write-data selecting unit 116 calculates a start position of input of the received data by returning from the end position of the last data input in the buffer memory 103 at the time of error detection, by the size of the data received until the time of the error detection calculated at the error-data specifying processing (step S301).

The disk write-data selecting unit 116 calculates an error data start position of the data received by returning from the end position of the last data input in the buffer memory 103 at the time of error detection, by the size of the error data calculated at the error-data specifying processing (step S302).

The disk write-data selecting unit 116 specifies effective data based on the calculated input start position and the calculated error data start position (step S303). When an error is not detected at the host-interface control unit 101, the received data entirely becomes the effective data.

FIG. 6 is a flowchart of the write-data merging processing mentioned in FIG. 3. In the write-data merging processing, the disk write-data selecting unit 116 compares the effective data specified by the effective-data specifying processing and other data in the buffer memory 103, and checks whether there are portions with a common write address (step S401).

When there is a portion with a common write address, a portion at the common write address in the older data, i.e., the data already stored in the buffer memory 103, is deleted (step S402).

The disk write-data selecting unit 116 specifies effective data in write data received from the host 200, and deletes data already stored in the buffer memory 103 at a common write address with the received data, so that write data accumulated in the buffer memory 103 to be written in the disk medium 108 is reconstructed by the data from which error data is removed. Thus, data loss in the buffer memory 103, which is caused by overwriting correct data with error data, is prevented.

The disk write-data selecting unit 116 stores data received from the host 200 in an unused area in the buffer memory 103, and the host-interface control unit 101 checks whether there is an error in the received data. When there is data in the buffer memory 103 at a common write position as effective data, which is data after error data is removed from the received data, the disk write-data selecting unit 116 deletes the data in the buffer memory 103 at the common write position. Therefore, even when data received from the host 200 includes error data caused by a communication error in the host interface 300, the error data can be removed, and the write data accumulated in the buffer memory 103 to be written in the disk medium 108 can be reconstructed by the data from which the error data is removed. Thus, data loss in the buffer memory 103, which is caused by overwriting correct data with error data, is prevented.

The magnetic disc device is described in the embodiment; however, the present invention is not limited thereto, and can be similarly applied to an optical disk device and a magnet-optical disk device.

According to an aspect of the present invention, even when data received from a host includes error data caused by a communication error in a host interface, the error data can be removed, and write data accumulated in a buffer memory to be written in a disk medium can be reconstructed by the data from which the error data is removed. Thus, data loss in the buffer memory, which is caused by overwriting correct data with error data, is prevented.

Furthermore, even when data is frequently transferred from the host, an unused area is automatically reserved so that data received can be stored in the buffer memory. Thus, data loss in the buffer memory, which is caused by overwriting correct data with error data, is prevented.

Moreover, an error can be deleted by finer units so that much of the data received from the host as possible can be written in the disk medium as effective data.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk device connected to a higher-level device via a serial interface and that writes data received from the higher-level device on a disk medium, the disk device comprising:
a buffer memory configured to store therein data;
a buffer writing unit that writes data received from the higher-level device in an unused area in the buffer memory;
a effective data deciding unit that checks whether received data includes an error, and decides effective data among the received data when the received data includes error, the effective data being data other than data corresponding to the error among the received data;
a common data checking unit that checks whether there is common data in the effective data and data already present in the buffer memory before writing the received data in the buffer memory to be written at same address in the disk medium; and
a deleting unit that deletes, when the common data checking unit decides that there is common data, data corresponding to the common data among the data already present in the buffer memory.

2. The disk device according to claim 1, further comprising:
a disk writing unit that writes data from the buffer memory to the disk medium; and
a space checking unit that checks whether there is sufficient space in the buffer memory for storing therein the received data, wherein
if the space checking unit decided that there is no sufficient space in the buffer memory, the disk writing unit writes the data present in the buffer memory into the disk medium and deletes the data from the buffer memory thereby creating space in the buffer memory for the received data.

3. The disk device according to claim 1, wherein the effective data deciding unit includes
a sector checking unit that checks whether the received data includes an error in units of sector, and
a sector effective data deciding unit that decides the effective data based on checking by the sector checking unit.

4. The disk device according to claim 1, wherein the effective data deciding unit includes
a packet checking unit that checks whether the received data includes an error in units of packet, and
a sector effective data generating unit that decides the effective data based on checking by the packet checking unit.

5. A method of writing data received from the higher-level device on a disk medium with a disk device, the disk device including a buffer memory configured to store therein data, the method comprising:
writing data received from the higher-level device in an unused area in the buffer memory;
first checking including checking whether received data includes an error;
deciding effective data among the received data when it is decided at the first checking that the received data includes error, the effective data being data other than data corresponding to the error among the received data;
second checking including checking whether there is common data in the effective data and data already present in the buffer memory before writing the received data in the buffer memory to be written at same address in the disk medium; and
deleting, when it is decided at the second checking that the buffer memory contains common data, data corresponding to the common data among the data already present in the buffer memory.

6. The method according to claim 5, wherein the disk device includes a disk writing unit that writes data from the buffer memory to the disk medium, the method further comprising:
third checking including checking whether there is sufficient space in the buffer memory for storing therein the received data; and
causing the disk writing unit to write the data present in the buffer memory into the disk medium and deleting the data from the buffer memory thereby creating space in the buffer memory for the received data.

7. The method according to claim 5, wherein the first checking includes
fourth checking including checking whether the received data includes an error in units of sector, and
the deciding includes deciding the effective data based on checking at the fourth checking.

8. The method according to claim 5, wherein the first checking includes
fifth checking including checking whether the received data includes an error in units of packet, and
the deciding includes deciding the effective data based on checking at the fifth checking.

9. A computer-readable recording medium that stores therein a computer program that implements on a computer a method of writing data received from the higher-level device on a disk medium with a disk device, the disk device including a buffer memory configured to store therein data the disk device, the computer program causing the computer to execute:
writing data received from the higher-level device in an unused area in the buffer memory;
first checking including checking whether received data includes an error;
deciding effective data among the received data when it is decided at the first checking that the received data includes error, the effective data being data other than data corresponding to the error among the received data;
second checking including checking whether there is common data in the effective data and data already present in the buffer memory before writing the received data in the buffer memory to be written at same address in the disk medium; and
deleting, when it is decided at the second checking that the buffer memory contains common data, data corresponding to the common data among the data already present in the buffer memory.

10. The computer-readable recording medium according to claim 9, wherein the disk device includes a disk writing unit that writes data from the buffer memory to the disk medium, the computer program further causing the computer to execute:
third checking including checking whether there is sufficient space in the buffer memory for storing therein the received data; and
causing the disk writing unit to write the data present in the buffer memory into the disk medium and deleting the data from the buffer memory thereby creating space in the buffer memory for the received data.

11. The computer-readable recording medium according to claim 9, wherein the first checking includes
fourth checking including checking whether the received data includes an error in units of sector, and
the deciding includes deciding the effective data based on checking at the fourth checking.

12. The computer-readable recording medium according to claim 9, wherein the first checking includes
fifth checking including checking whether the received data includes an error in units of packet, and
the deciding includes deciding the effective data based on checking at the fifth checking.
